(19) United States
(12) Patent Application Publication
(10) Pub. No.: US 2007/0061199 A1
(43) Pub. Date: Mar. 15, 2007

(54) System and Method for Creating Customer Intimacy With A Brand

(76) Inventors: Mark Montgomery, Pegram, TN (US); Neil Einstman, Nashville, TN (US); Dale Stepniewski, Nashville, TN (US)

Correspondence Address: W. EDWARD RAMAGE, COMMERCE CENTER SUITE 1000, 211 COMMERCE ST, NASHVILLE, TN, 37201, US

(21) Appl. No.: 11/470,224

(22) Filed: Sep. 5, 2006

Related U.S. Application Data
(60) Provisional application No. 60/745,645, filed on Apr. 26, 2006.
(60) Provisional application No. 60/714,148, filed on Sep. 2, 2005.

(51) Int. Cl. G06Q 30/00

(52) U.S. Cl. 705/14

(57) ABSTRACT

A system and method for creating, implementing, managing and analyzing various elements of a strategy for creating customer or audience intimacy with a brand, including but not limited to an individual, concept, group or other entity. One exemplary embodiment includes, but is not limited to, a set of tools for building and managing an online community entered on the brand or entity. These tools include a plurality of databases; a plurality of customizable website content-management modules; webmail and email-tracking services; additional tracking methods for a variety of marketing campaigns and events; client administration modules; and sales and accounting modules.

This application claims priority to Provisional Patent Application No. 60/745,645, filed Apr. 26, 2006, by Mark Montgomery, et al., and Provisional Patent Application No. 60/714,148, filed Sep. 2, 2005, by Mark Montgomery, et al., and is entitled in whole or in part to those filing dates for priority. The specification, drawings and attachments of Provisional Patent Application Nos. 60/745,645 and 60/714,148 are incorporated herein in their entirety by reference.

### FIELD OF INVENTION

This invention relates to a system and method for creating, implementing, and managing a database, online and/or offline, relating to promotional, marketing, and publicity activities for a brand, where a brand is broadly defined to include a brand name or image associated with a particular product or service, any person, individual, group, entity, corporation, organization, club, agency, item, product, service, activity, subscription, sport, game, country, idea, concept, or combination thereof. More particularly, the invention relates to the creation of a plurality of tools and actionable information for the mining and tracking of data and the management of materials and related resources in conjunction with marketing and consumer management services, designed to engage and retain consumer interest in a brand.

### BACKGROUND OF THE INVENTION

The marketing environment has changed substantially with the growth of the Internet and the use of personal computing devices. The environment is one of constant change, with consumers with short attention spans moving rapidly from site to site, from stimulus to stimulus, from information source to information source. The typical Internet consumer is accustomed to multitasking and the rapid processing of information.

As part of this new environment, consumers have become increasingly likely and willing to access a desired brand or similar commercial entity through the Internet as the preferred channel. Accordingly, the Internet is where a brand's relationship with its customers begins and possibly develops. Traditional brand management and marketing approaches cannot handle the wealth of information provided in this new environment, much less process and proactively respond to this information.

Accordingly, what is needed is a system and method for creating, implementing, and managing an Internet-based mechanism for promotional, marketing and publicity activities that gathers information about a customer or end-user intuitively, maintains this information logically and securely, and processes the information quickly and creatively, in order to seize the attention of an audience and its members, increase the size of the audience, and to maintain and develop that relationship.

### SUMMARY OF THE INVENTION

In one exemplary embodiment, the present invention comprises an Internet-based marketing system for a “brand.” “Brand” includes, but is not limited to, a brand name or image associated with a particular product or service, any person, individual, group, entity, corporation, organization, club, agency, item, product, service, activity, subscription, sport, game, country, idea, concept, message, unique content, or combination thereof.

The system comprises a variety of modules and tools designed around a database structure. The various modules and tools provide a host of functions for content management, the creation and communications of messages to an audience, marketing, and ecommerce and reporting capabilities, all fully integrated.

In one exemplary embodiment, the system provides physical and digital reporting on a multitude of marketing level activities. Digital reporting capabilities include the ability to create and track multiple campaigns and their overall effectiveness using currently acquired and historical information, as well as the multiple events or segments that may be contained within the campaigns, such as email marketing, advertising, editorial placement, end-user initiated promotions, forward-to-a-friend, Wiki-generated placement, mobile broadcasting event marketing, text-in event marketing, and other event-related marketing tactics. As campaigns are executed, the historical data resulting from earlier campaigns and events help craft and guide future marketing strategy as well as the return on interest pertaining to the segments and events. Physical reporting includes, but is not limited to, direct mail or street level marketing. The system provides the ability to quantify effectiveness through feedback and measured responses to individual pieces of serialized mail or to promotional materials provided to the street level marketer for distribution.

In another exemplary embodiment, the invention provides the ability to target audiences with messaging relevant to their interests, and also within the time constraints as with time sensitive messages. It also has the capability of a technological interactive mapping mechanism allowing the narrowcasting of target marketing events at the optimal time to achieve the greatest impact. In yet another embodiment, the system obtains and maintains data rich profiles (e.g., community behaviors, purchasing habits, individual response rates to emails, and the like), end user polls, surveys and similar data allowing the user to more accurately gauge reactions to existing products and services, as well as forecast product mix. Filters also can be used to sort the data in a variety of ways.

### DESCRIPTION OF THE DRAWINGS

FIG. 1 shows a schematic diagram of elements of a marketing system for a brand in accordance with one embodiment of the present invention.

FIG. 2 shows a schematic diagram of elements of a marketing system for a brand in accordance with another embodiment of the present invention.

FIG. 3 shows a schematic diagram of a database structure for a brand in accordance with another embodiment of the present invention.

FIG. 4 shows an element of a web site in accordance with another embodiment of the present invention.

FIG. 5 shows a locator tool in accordance with another embodiment of the present invention.

FIG. 6 shows a schematic diagram of a campaign in accordance with another embodiment of the present invention.

FIG. 7 shows a schematic diagram of campaign results in accordance with another embodiment of the present invention.

FIG. 8 shows a schematic diagram of elements of a marketing system for a brand in accordance with another embodiment of the present invention.

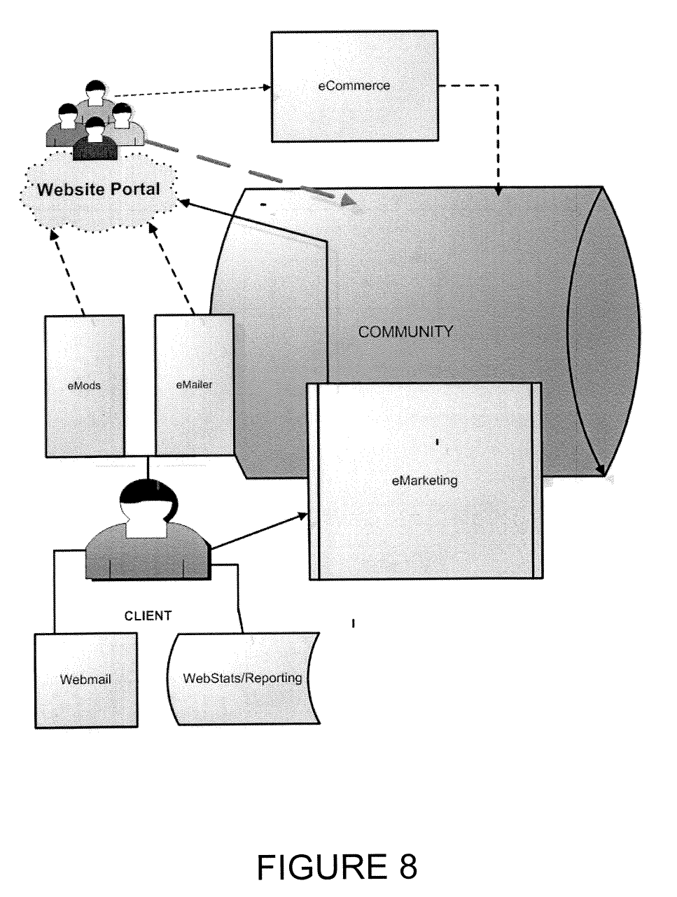

### DETAILED DESCRIPTION OF THE INVENTION

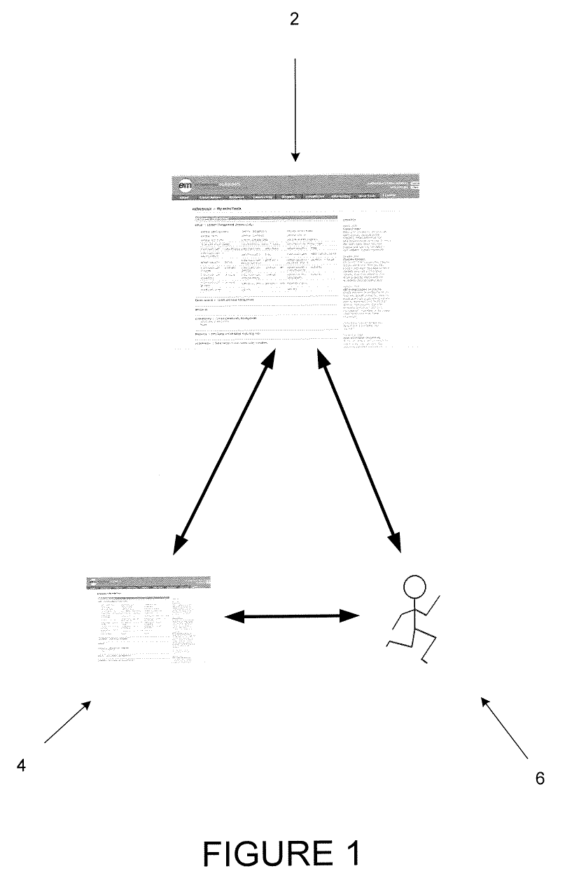

Referring now to the numerous figures, wherein like references identify like elements of the invention, FIG. 1 shows an overview of an Internet-based marketing system for a “brand” in accordance with one embodiment of the present invention. “Brand” includes, but is not limited to, a brand name or image associated with a particular product or service, any person, individual, group, entity, corporation, organization, club, agency, item, product, service, activity, subscription, sport, game, country, idea, concept, message, unique content, or combination thereof.

In one exemplary embodiment, as seen in FIG. 1, the system includes a central web site 2, or web portal, which serves as the central focal point, or information-gathering and dispensing hub, for the brand. The central web site 2 contains content relating to the brand, or interests related to the brand, including but not limited to text, images, audio, and video content. The central web site 2 also may contain various information and management tools related to other elements of the system, tools for collecting and manipulating data, and links to related information and sites. Some or all of these tools and links may be accessed by various levels of site administrators, managers, users and consumers. In one exemplary embodiment, the web site is designed with an engaging front-end user interface to capture and retain the attention of an end user, consumer, or audience 10 thereby making the information-gathering process more successful in gathering more complete, specific, and valuable information.

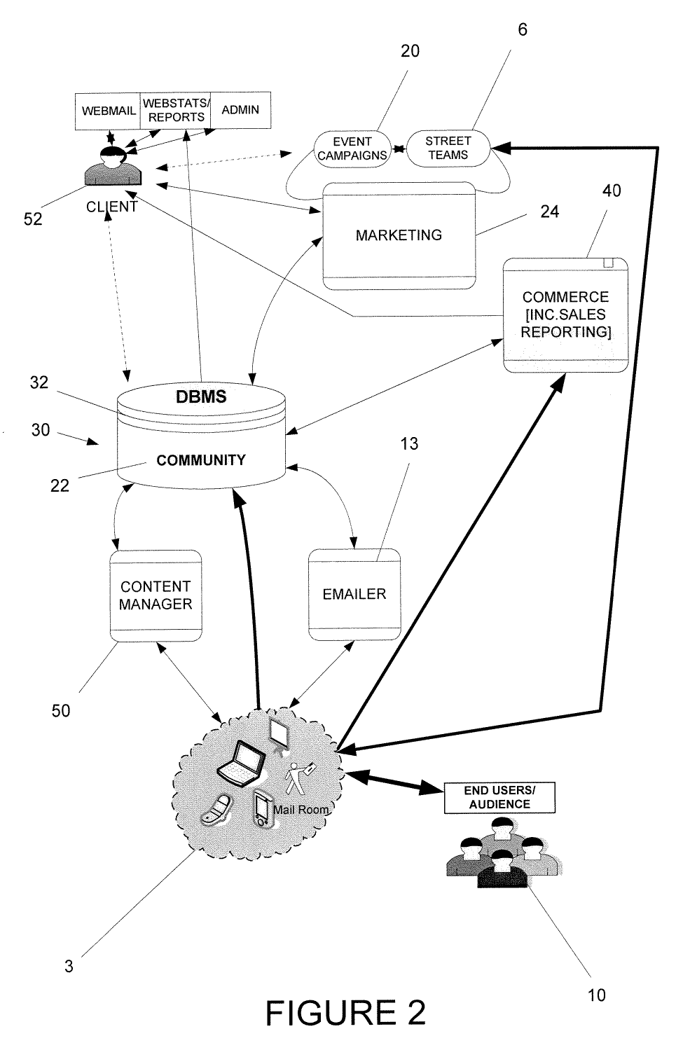

As shown in FIG. 2, in other exemplary embodiments, means other than a central web site 2 may be used as primary means 3 of dispensing information or content to audience members.

The system can work with a broadcast and/or “push” models for content distribution and communication, but is particularly effective with a narrowcast and/or “pull” models. A narrowcast is the transmission of data to a specific list of recipients. The Internet uses both a broadcast and a narrowcast model. Most web sites are on a broadcast model since anyone with Internet access can view the sites. However, sites that require one to log-in before viewing content are based more on the narrowcast model. An example of narrowcasting is electronic mailing lists where messages are sent only to individuals who subscribe to the list.

“Pull” distribution indicates a demand-driven model, one in which the customer or “fan” base actually seeks the product to order or chooses to seek out information on a brand. This is in contrast to “push” distribution, where a producer “pushes” things towards customers or the audience. The push/pull distinction is based on the product or piece of information and who is moving it. A customer “pulls” things towards themselves, while a producer “pushes” things toward customers.

In another exemplary embodiment, the invention includes a set of tools for building and managing an online community centered or focused on the brand. The online community may include, but is not limited to, a membership organization 4 and street team 6.

The system helps to establish positive brand recognition through repetitive contact with a community or an audience of users or consumers 10. The audience is identified as receptive through not just opt-in methodology, but double opt-in enrollment and subscription methods. Opt-in is the action of being asked permission to or to agree to receive emails from a particular company, group of companies, group, association, or organization by subscribing to an email list. Double opt-in refers to an additional step of seeking confirmation for the subscription, which helps ensure that the email address is valid and that the subscription was not an error or mistake, or an unintended or malicious action by someone else. Thus, a new person visits a web site or page, initiates a subscription by supplying an email address to the enrollment process, and then confirms their agreement to subscribe or join upon or after receiving an email asking if it was really his or her intention to subscribe to the specific mail list.

This double opt-in methodology allows a subscriber to be considered “whitelisted.” An email whitelist, generally, is a list of contacts (potentially including sources and recipients) that the user of the email list considers to be acceptable and that should be retained. Internet Service Providers (ISPs) may have whitelists that they use to filter email to be delivered to customers. Companies may request being added to the ISP whitelist of companies, and typically must meet some specific requirements to be eligible for the list.

The system is highly relational, and is based on the pursuit of the initial relationship with the audience or end-user 10, and the integral maintenance of each relationship in that audience. Thus, for example, a member of the audience may accidentally discover the brand web site 2, or do so as the result of an initial marketing incentive or campaign 20. An engaging and interactive web interface at the site 2 captures or captivates the audience member, in some embodiments using permission-based offers and strategies, who then willing provides certain personal information to begin the brand-consumer relationship. Ongoing communication continues, with data being stored in a robust relational database structure 30. Data is processed or filtered to maximize knowledge of the user and audience, thereby enhancing the ability to fashion and relay subsequent messages to an open, receptive audience. The ongoing communications with the customer/user results in commercial transactions 40, such as ticket sales, product sales, downloads, and the like, which also are captured in the database. The ongoing dialogue between the customer/user and the brand results in the continuing return to the website and additional information, allowing the brand to build on and nurture a “one-to-one” or intimate relationship with the customer/user. The result is a positive customer/user experience, growth of the brand, and extremely positive brand image.

The system includes a dynamic database structure 30 comprising one or more separate databases 32 that collect, store and distribute information from or about the audience or community 10 and anything related to the brand. Information can be provided by or from any source. Databases may be online or offline, or some combination thereof. The database structure 30 unifies information including, but not limited to, content about or concerning the brand, user or consumer behavior, and communications. Through a variety of drivers, an ongoing cycle of information input and feedback is maintained that results in high levels of usage and loyalty among customers over substantial periods of time. This includes, but is not limited to, high open rates, click-through actions, sales, and customer retention, ultimately resulting in increasing the value and recognition of the brand. Open rate is the number, or the percentage, of emails sent by an entity that are actually opened by a receiver. This can occur when the sender embeds an html image into the email sent and when the receiver clicks on or opens the email it will result in an indication to the sender that it was opened. Click-through rate (CTR) is a way of measuring the success of an online advertising campaign. A CTR is obtained by dividing the number of users who clicked on an ad on a web page by the number of times the ad was delivered. For example, if a banner ad was delivered 100 times and 1 person clicked on it (i.e., 1 click recorded), then the resulting click through rate would be 1%. Similarly, 40 people clicking on it would result in a CTR of 40%.

A number of brand databases and database structures 30 may be a part of a larger database structure that includes database structures for two or more brands. Alternatively, a larger database structure may be divided, logically and/or physically, into separate internal databases or database structures, each corresponding to a brand.

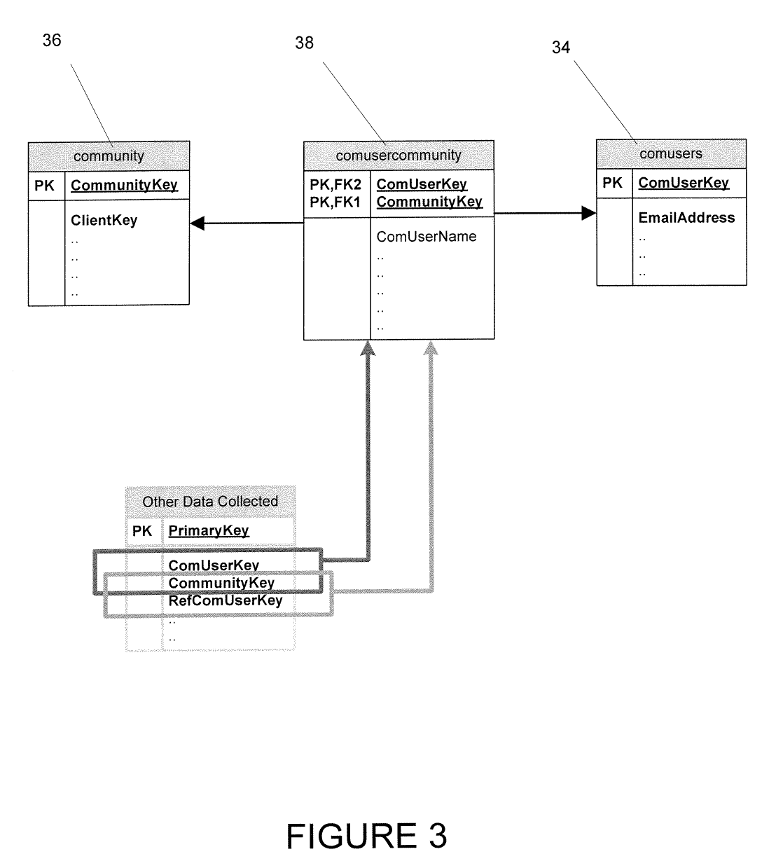

In one exemplary embodiment, as shown in FIG. 3, the database structure 30 includes a distinct structure for users/consumers 34 (e.g., ComUserKey) and a separate distinct structure for communities 36 (e.g., CommunityKey). The users structure 34 and the communities structure 36 are combined in a distinct joint key (e.g., CommUserCommunityKey) 38, which is the primary key for all database unions, and property and attribute inheritance. This unique database design, combined with other database elements, permits the simple and rapid tracking, mapping, reporting, and analysis of users/consumers and communities, as well as global information and characteristics (e.g., demographic, psychographic, and geographic).

Demographic information includes, but is not limited to, race, age, income, mobility (measured in a variety of ways, including travel time to work, number of vehicles available, and the like), educational level, home ownership, employment status, and location. Psychographic information includes, but is not limited to, attributes relating to personality, values, attitudes, interests, tendencies, behaviors, or lifestyles, and are frequently referred to as IAO variables (Interests, Attitudes and Opinions). Geographic information includes, but is not limited to information about location, state, city, and the like.

The inheritance of user and community attributes within the database structure 30 can be shown with an example of a street-team 6 mission. Users within a community may be designated as a member, or potential member, of a street team 6. Each user within a community having street team status may be issued a serialized number and/or a serialized marketing URL (Uniform Resource Locator). The distinct joint key (i.e., ComUserCommunityKey) 38 becomes a reference key to any activity resulting from the serialized number or marketing URL, including, but not limited to, clicks on a webpage, new user sign-ups, sales, downloads, and the like. Each of these activities is efficiently linked back to the reference user and to the new user via the ComUserCommunityKey 38, and is then reportable on a user, community, and/or global level.

In one exemplary embodiment, the database for a particular brand, including all of the information provided relating to that brand, and information collected from and about users and consumers, may be referred to as a community 22. The community 22 is dynamic and integrated, thereby driving the system and increasing its use for marketing 24. Data collected from an audience of users or consumers 10 typically with change or expand over time, based upon the means and initiatives used to make the initial contact with those users, and capture and maintain them.

Personal data and information collected from the audience of users and consumers 10 is collected through a variety of methods, including, but not limited to, some or all of the following: email subscriptions, mobile communication subscriptions, affiliate marketing efforts, club memberships (including tiered memberships), message board or forum subscriptions, message board or forum participation, street level marketing groups and memberships, weblog, blog back and/or chat participation, surveys and polls, contests and giveaways, promotions, and sales. Affiliate marketing is a method of promoting web businesses in which an affiliate is rewarded for every visitor, subscriber and/or customer provided through his efforts. It is a modern variation of the practice of paying finder's-fees for the introduction of new clients to a business. A weblog, which is usually shortened to blog, is a type of website where entries are made (such as in a journal or diary), typically displayed in a reverse chronological order.

The community may include a membership organization 4, such as a fan club or similar organization for groups interested in the brand. The membership organization 4 may be a part of or organized through the central website 2 or it may be an independent site. Membership can be open or subscription based, or a combination thereof. Membership can be online or offline, or a combination thereof. In one exemplary embodiment, members typically would have access to exclusive information and features about or concerning the brand. Examples of exclusive information and features include, but are not limited to, advance notice of events, online VIP ticketing, concert meet-and-greets, streaming video, exclusive photo galleries, tour journals, news, contests, special product offers, sweepstakes, and similar activities or events, suitable for the nature of the brand.

The community also may include what is known as a street team 6. A street team 6 can be organized online or offline, or a combination thereof. It can be involved with promotions and publicity in connection with particular events, such as a tour. These activities can occur offline as well as online. Thus, for example, a street team 6 can conduct concert- and event-level marketing initiatives, distribute promotional materials and exclusive music content, and conduct attention-grabbing activities in public. Teams also can participate in market research, and new or beta product testing. A particular brand can have multiple street teams.

Information collected may be provided on a permission basis by the users and consumers through double opt-in methodology (which can be compliant with applicable security and privacy laws, including but not limited to the Children's Online Privacy Protection Act, or “COPPA”).

The community module not only manages the brand data residing in the database, some of which is used to generate the content of the web site 2, but also provides additional functions which allow brand managers, clients, users and consumers with appropriate permission levels to further sort, manage, and/or control functions and responses within the function.

A variety of different configurations of filters may be applied to the collected and stored community data. Application of several of these filters can provide an intuitive depiction of the brand, and its consumers and users, whether individually or in groups or sub-groups. Multiple filters can be stacked or nested. These advanced filters result in much more than a simple re-organization of the data; they provide a brand or client with multi-faceted pictures or snapshots of the audience and its members. They provide the means for a brand or client to target audiences with messaging relevant to their interests and activities, leading to more of a one-to-one relationship between the brand or client and the audience members or users.

The data being filtered itself can be layered (i.e., contain numerous parameters, which in turn provides further detailed results. Examples of this include, but are not limited to, email campaign data (e.g., email sent, opened, bounced, unread, response rates, etc.); status/levels of the audience member (e.g., paid member, street team member, login member, moderator, administrator, etc.); gender; meet and greet participation; street level marketing participation; poll participation; referrals; sign-up dates; user preferences as to music, television, product, etc. (including preferences collected from ongoing communications); sales numbers of inventoried items (e.g., quantities of items, types of items, dates purchased, dollars generated); ticket sales (e.g., event, type of event, number purchased, dates purchased, dollars generated); address and region (e.g., state, city, zip code); email history (e.g., rate of unopened, opened, clicked through, forwarded and bounced); memberships (by zip code or regions); message board or forum participation (e.g., number of postings, last posting, overall visits); survey and contest participation (e.g., dates of survey or contest, response details, results); and marketing campaign results.

Parameters and criteria used to build customized filters can be saved as a dynamic query, the results being used in a variety of future and ongoing communications, campaigns and event planning (e.g., email, wireless, text messaging, direct mail, cell phones, etc.). The results are not static, but are updated automatically as subsequent additions or changes to the community database are made (assuming, of course, that new additions meet the filter criteria). For example, a saved filter built on Jan. 1, 2006, to determine and identify fans in the Southeastern United States who are female and over 25 years of age will automatically update to add a new member opting into the community (i.e., whose information first appears in the database) on Jun. 2, 2006 with a Georgia zip code, if she is female and over 25 years of age. While a number of filters are dynamic, a “snapshot” feature is also available to capture the results generated by a filter at a specific point in time.

A web form module permits a user with appropriate permissions to design forms for a variety of ways of gathering customer audience information. The user may start with a pre-designed form template, or start “from scratch.” A question pool is used to design the form and set the permission levels for various events and campaigns. Form templates include, but are not limited to, registrations, contests, surveys, groups, exclusive events, meet and greets, polls, free content downloads, feedback forms, gift codes and serialized promotions. The resulting data is unique.

The invention uses serialization as a marketing, reconciliation, and tracking means. As an example, marketing provides a serialized card (i.e., a card with a unique serial number) for free downloads to members of the street market team, who distribute the cards as part of a promotion. Upon redemption, the serial number is captured and entered in the database, where it is tied to the street team member (who may received credit), the new member or user of the card (who is required to provide basic information in order to be able to download), and any other activities or persons related to the card. Serialization is also the means, when conducting a contest, to discern the person or persons winning or qualifying for the reward. Accordingly, with serialization, data can be tied back to particular individuals (or an action or a source) on both the redemption and referral levels. Serialization is not limited to street teams or cards, but can also be used with various forms of mailings, including physical mailings, and other forms of distribution of information. This provides a unique method of bringing several elements together, both for a specific marketing campaign and at a broader level.

A list function provides details about audience and community members to clients or users with appropriate permission levels. Lists can be focused. For example, a list can provide detailed information about recipients of emails, text messages, voice messages, and the like. In addition to detailed information about the members, information about non-COPPA compliant and underage members also may be available. Other examples of lists include a list of invalid email addresses, or those email addresses awaiting a response to an opt-in message.

In another exemplary embodiment, a content management module 50 is used to organize and provide access to a variety of tools used to create, add, remove, update and archive content on the central website 2 or websites for each brand. In the present context, this module enables contact with audience members 10 to remain current and “fresh.” Each piece of content in the client database may be configured with templates, which may be customized, that support a variety of combinations of visual or architectural preferences. The content management module 50 permits a client 52 or user with appropriate permission levels to maintain, modify, or update the website 2, even though the client 52 or user does not have any technological expertise or familiarity with languages used to form web sites (such as HTML, Hypertext Markup Language, or XML, Extensible Markup Language). The content management module not only has extensive imbedded functionality, but its architecture is designed and built such that it is compatible with and support both industry standard or user tailored plug-in modules. A WYSIWYG (What You See Is What You Get) editor may be provided. The WYSIWYG editor also may allow the user to easily commit text as web content through the use of industry standard plug-ins. This permits the client 52 or user with appropriate permission levels to have a significant measure of creative control over website content, while also encouraging them to maintain or update content on a frequent, consistent basis, thereby keeping audiences and community members interested, hungry for new information, media, and content related to the brand, and engaged in returning to the web site 2.

A user may easily create new content formats by designing a new template. The new template can be modified from existing templates, or formed by selecting certain fields to be included, choosing a location for the selected fields, and then saving the resulting template design. Templates also may be established for a brand, or particular user. Templates, along with content added to the web site, may be saved in the brand specific database 30. Templates may be ordered by date, title, or category, and may include various types of media, including text, graphics, audio, video, streaming content, PDFs, and entries from other templates. In one exemplary embodiment, the types of fields that may be selected to form a template include, but are not limited to, blogs, event calendars, image galleries, multi-media, polls, surveys, links, touring schedules, and venue information. Portions of website content may be designated as inactive by the click of a button, or removed completely. The content management process results in instantaneous updates to the client web site, if desired, although content to be added can be post-dated to be automatically added to the web site at a later time.

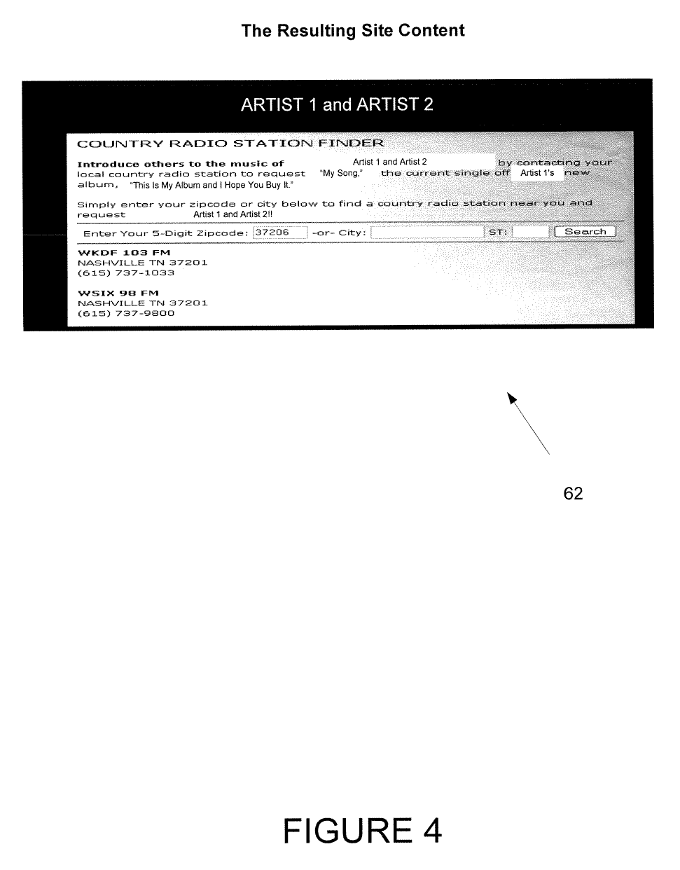

One example of content that may appear on a brand web site 2 where the brand is a singer or band or musical artist is a message 62 providing information to the viewer about which radio stations or performance venues in the viewer-selected area represent or play the singer or band or musical artist in question, or which local radio stations or venues play songs in the same genre. The viewer may then be prompted to call or contact their local radio station or a provided venue to request a particular song (such as a current single) by the singer or band in question, or to suggest that the venue host or represent the singer, band artist, etc., as seen in FIG. 4. The viewer may be prompted to enter location information (e.g., zip code, city and state, or an address), and is then provided a list or display of appropriate radio stations or venues.

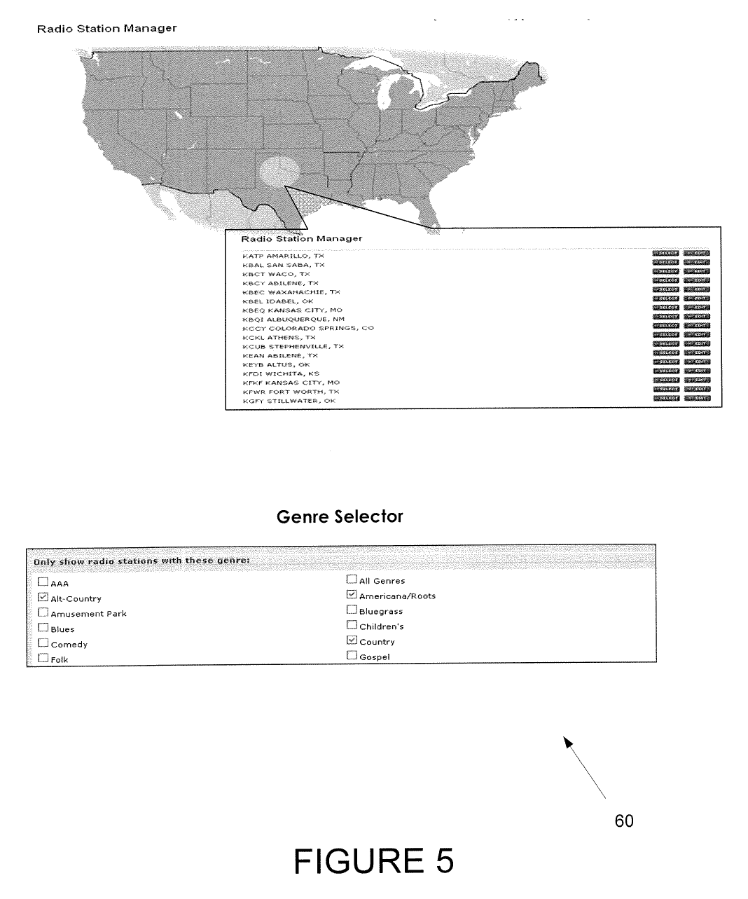

As seen in FIG. 5, the locator tool 60 in the content manager module 50 provides the means for a client or user with appropriate authorization to add a locator feature as described above to the web site for a particular audience or community. Activating this tool causes a map search tool to be displayed, which permits the client or user to search a selection region or area for radio stations. Alternatively, a list of potential radio stations or venues can be obtained by simply entering a zip code. The radio station search can be further limited by a variety of variables, such as genre. The client or user has the ability to pre-select the genre. The client or user then may peruse the resulting list of radio stations or venues, and select stations or venues to be added to the locator feature of the web site 2.

In addition, the system can take existing market data (such as from Soundscan, for example), and overlay that information on community data to obtain a more complete picture of the userbase and audience geographically and demographically. This assists in accomplishing a multitude of functions, including more targeted physical distribution, routing, and event marketing.

A brand can have one or multiple forums and message boards, which may serve as a focal point of interaction with and among audience members interested in the brand, as well as data generator for the database. These are managed using a message board module. A client or user with appropriate permissions can set up message boards for the brand in a variety of ways. Typically configurations include forming message boards by forum heading and thread title. Permission levels can be assigned within each forum, and certain status levels (such as moderator) can be assigned to particular individuals. The client or user can also set date ranges the particular forum or thread being created may be active and open to posting, and when it may be removed.

A client or similar user also can establish membership or access levels for members of the community, and the criteria for each level, including but not limited to pricing for each level, payment means, duration, the number of days prior to expiration date that a member will receive a renewal reminder, and the like.

Clients or users with appropriate permissions also may assign ticket groups exclusively for purchase by members of the online community, or subsets thereof. Tickets may be assigned by date of event, price level, seat assignment selection (e.g., general admission, specific seats, seating charts), and the like. The ticketing function of the system can provide real-time information about ticket sales, including information provided by the purchaser, sales date, invoice number, transaction number, quantity sold, sales amount, and the like. All information is exportable to files in a variety of formats, including but not limited to csv files. Ticket groups can be assigned by membership or access levels for incentive campaigns and other events, as well.

Clients or users with appropriate permissions also may construct a street level marketing campaign, mission or event comprising members of the community who have indicated their willingness to participate. Participation may be compensated or not compensated. Compensation may be in the form of product, recognition, points, money, rebates, or similar items. The street level marketing campaign or mission formation function may include, but is not limited to, the assignment of members to specific tasks, and assignment of resources supporting those tasks. The function also may include the means to capture and management the participation, such as a point store or record, and member or community response.

In an exemplary embodiment, the system also includes a message management component 13. The message management component 13 functions as the distribution portal for communications sent regarding the brand to the community, and vice versa, in a variety of formats, including but not limited to email, mobile and wireless text messages, forum or message board postings, broadcasts or “big screen” displays at events, SMS (short messaging service), Bluetooth, private and instant messaging, open and/or scheduled chats, and voice messages. These messages can be proactive and/or reactive, serving as notification and escalation based on criteria or triggers that both the member and the client or manager of the brand can set and control. Communications may adhere to a double opt-in methodology as described above. This allows “whitelisting” status on all major portals. This methodology further enhances the brand image by restricting or disallowing spam messaging, reinforces community loyalty by ensuring the trust and security aspects of the relationship, and further prevents the waste of resources by confirming the authenticity of the audience.

A client or user with appropriate permissions may create communication messages anew, may select one or more pre-set templates, or may use a configuration tool to design the message. Template designs allow for focused communications to the various levels of membership in the audience population, and may also be used to target a specific demographic (based upon, for example, age, gender, zip code, and the like). Communication may remain in draft form until ready to be sent or distributed, whereupon it is moved into the appropriate channel (e.g., an outbox) and transmitted. Transmission may be immediate, set to a designated time or times, or may be broadcast or transmitted to smaller segments based on their “most likely” times to receive that messaging. For example, females between 20-34 years of age are more likely to be online and receptive to messaging between the hours of 8:30 p.m. and 11:00 p.m., and thus messaging directed to this group can be delivered during those timeframes.

Once a communication is created and sent, the system tracks and traces the progress of each communication to an individual member. This includes, but is not limited to, information about when the communication is sent, when it is opened, when it is clicked through (again tracking CTR), what is clicked on/through, product sold as a direct result of the communication (which affects return on investment), and if/when it is bounced. In an exemplary embodiment, a communication can be created and sent to all of a brand's paying membership base exactly 14 days prior to membership expiration to remind members of the upcoming expiration, and a follow-up communication 5 days following the date of expiration to remind them of the expiration. This provides highly useful data about the success and/or impact of the communication. This data may include, but is not limited to, the details on the number of people using the reminder to pay their expiring membership, the number of females vs. males that renewed, the number that did not open the messages, and the comparative success rate of notification before the expiration and notification after the expiration. In one exemplary embodiment, the tracing results are collected and written to individual user profiles in the community database, which then can be filtered globally or individually. The system also can provide (in one exemplary embodiment, by a single click) details by groups, such as the total number of messages sent, opened, clicked through, and/or bounced, making it simple to correlate information. For example, the number of those clicking through on a particular email message can be tied to detailed information about that group, showing the levels of membership they have, region or area in which they live or reside, and whether the success for click through has increased in conjunction with some other recent event, such as an advertising campaign.

The varying levels of detail that can be derived through this component can be tied to marketing efforts to gauge the success of those marketing efforts. It also can be used to building marketing plans for the future. The information may further be linked with and used with sales and accounting information 40 to determine the financial impact of any communication effort or campaign, individually or grouped.

In one exemplary embodiment, the email system 13 may include a multiple template-driven, WYSIWYG, HTML email gun that supports multipart-MIME (Multipurpose Internet Mail Extensions, an Internet standard or specification for formatting e-mail so that it can be easily sent over the Internet) and HTML. It also may include a fully-integrated bounce handler. Additional functions include, but are not limited to, a “forward to a friend” option. When tied to a marketing campaign, the system can deliver to multiple distribution channels, including cell phones, text messaging devices, PDAs, and the like. The system also may maintain a complete mailing history for each individual user.

The email system also may include a basic webmail portal that can accommodate numerous users and operates on a standard interface, allowing users to access email from any browser.

A commerce module 40 provides a system for tracking a wide variety of sales and commercial transactions, collecting that information in the community database, and providing a variety of reporting mechanisms. Sales may be made from any source, but the system includes means for creating, establishing and operating an online-store, which permits for direct tracking of sales and collecting of information by the system. Commercial transactions include, but are not limited to, ticket sales, product sales, media sales, media download sales, and membership purchases. Sales are tracked through a sales reporting mechanism which collects the information and enters it in the community database, where it can be tied to an individual member. Sales can be sorted or filtered in a variety of ways, including, but not limited to, sorting sales by item (e.g., blue T-shirts by size), item type (e.g., T-shirt), community level (e.g., street marketing member, free member, etc.), regional sales, and vendor number. The information may also be organized by desired sales period and/or campaign periods. Items included in inventors also are more easily tracked and employ the use of minimum/maximum levels to ensure available stock and prompt order fulfillment. All report data and inventory information is exportable in a variety of formats.

In one exemplary embodiment, brand-related content (including advertisements) may be displayed in various types of video games. The system can arrange for such displays as a data source, and also can track responses of audience members to the brand-related content in the games. In some embodiment, advertisements, including but not limited to text, audio, video, SWF, etc., may be fed into the games through Internet connections, and can be updated and refreshed utilizing the content management tools of the present invention. Each advertisement can be assigned a serialized marketing URL, deep-linking the game player directly into the brand's customized landing page, offers, and the like.

A marketing module 24 provides advanced means for measuring the success of a marketing message, campaign or event. It uses information in the community database, as well as information from other sources, to design and build marketing campaigns, tactics, portals, events, and messages based upon evaluation of prior successes and failures. Success can be measured by response rates, renewals, and monetary results, including but not limited to memberships purchased, product purchased, increase in website traffic, increased saturation of brand knowledge and awareness, and the like.

Campaigns are broad marketing efforts related to a brand, and can include the delivery of a desired message to consumers and community members. Examples of campaigns include, but are not limited to, contests, special events, product releases or promotions (e.g., audio, video, physical, digital, tickets, and the like), upcoming tour or tours, street level marketing, television spots, traditional ad buys (with pushes to the web), radio spots and back announcing, and new membership drives.

Campaigns may be designed for a specific or particular brand, with the goal of creating interest and excitement about the brand by setting up events to promote the brand. This results in the acquisition of data and information for the community database, which in turn may be used to create and further the relationship with the audience and community.

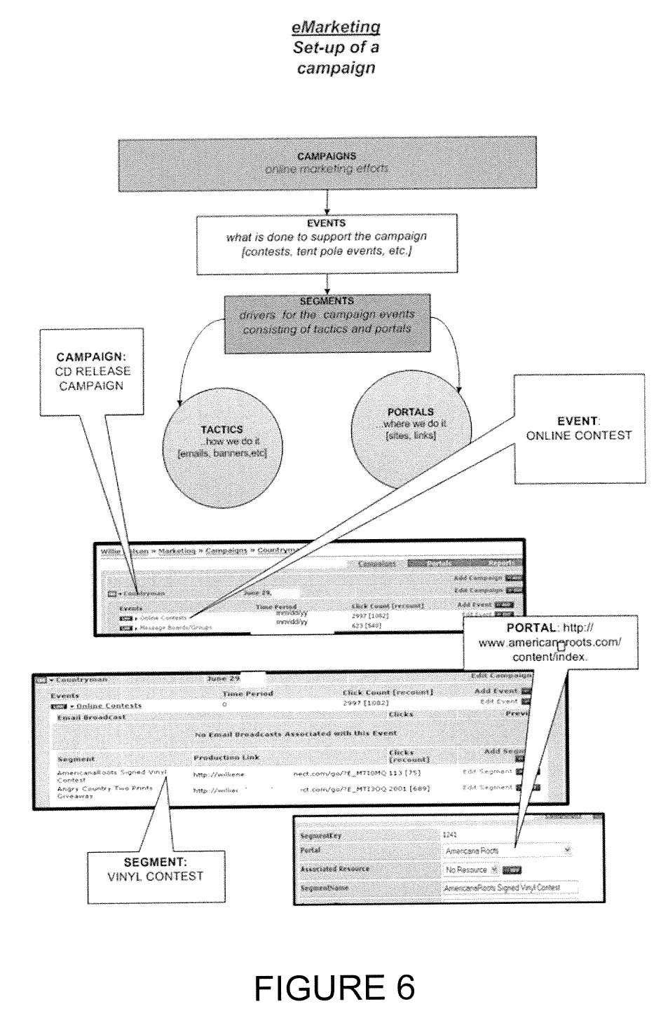

As shown in FIG. 6, campaigns may be online as well as offline, or any combination thereof. Online campaigns include online marketing efforts tied to a particular, quantifiable offline promotion, provide the end result of the offline promotion is an online transaction or visit. If the online destination is the brand website 2 within the system described herein, the campaign information links directly to the site and the community database. Alternatively, campaign templates specific to a campaign may be hosted on a site connected to the community database, to promote the efficient collection of data.

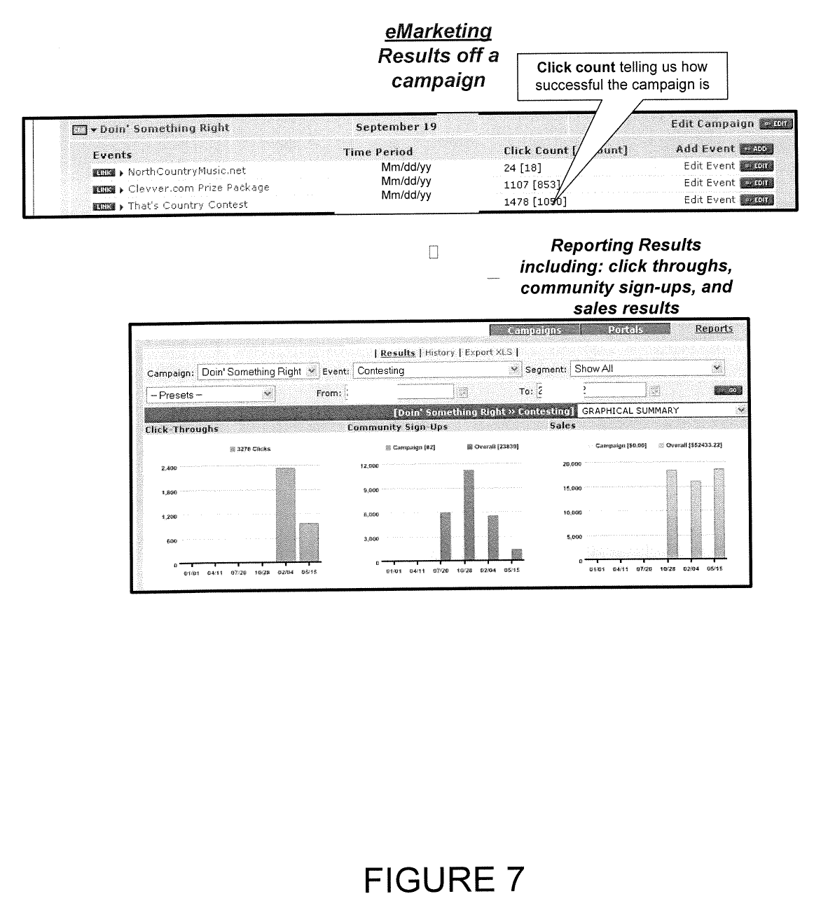

In one exemplary embodiment, as seen in FIG. 7, results of a campaign are quantifiable through tracked links, which may be generated from a unique URL generator. The tracked links will report on clicks (which may be further identified as clicks from unique URLs), signups, sales generated, forwards to friends, contacts, responses, and the like. Reporting encompasses not only aggregate results for a campaign, event, or segment, but also detailed actions and response for particular individuals or audience members. In addition, along with tracking “clicks,” the system can allow a more in-depth analysis of campaign effectiveness. For example, a unique click may have a certain value, but a click followed by a sign up to join the community has a greater value. And a click followed by a sign up, followed by purchase has even greater value. The system permits the quantification of activities at this level. Reporting can include customized reports for a particular brand, as well as a suite of standard reports. This not only allows analysis of the success of the campaign or its components, but provides predictive analysis for future marketing plans.

The resulting data thus provides a depth of information enabling an accurate, detailed picture of the consumer or audience member, individually or grouped. As campaigns are executed, the data can be monitored in real-time, or one some other basis, and adjustments to the campaign may be made. In addition, historical data from prior campaigns is stored in the community database and is available to assist in designing, creating, and guiding future market strategies, including other campaigns.

The data also enables the calculation of “return on investment” (ROI) pertaining to segments and events. Events are the vehicles or mechanisms used to establish and deliver the campaign message or messages. Examples of events include, but are not limited to, tent pole events, online contests, giveaways, and the like. Segments are distinct ways and means used to establish the campaign message or message, including, but not limited to, email, banners, text messaging, voice messaging, crosslinking efforts, and the like. Tactics include how the message of the campaign is delivered through a particular segment or event, and portals may be assigned to a segment based upon the delivery method chosen.

In another exemplary embodiment, a web stats module provides graphical and numerical summaries of activity on the brand web site 2. The module also may support plug-ins from the user or third party programs. These summaries may be divided into time periods, and may be viewed in snapshot fashion. Information provided may include daily average and monthly totals for site activities. Activities tracked include, but are not limited to, number of hits, files, visits, and bandwidth, among others. The same levels of tracking and review as described above also are applicable to this area.

In yet another exemplary embodiment, an administration module may be provided for clients or users with varying levels of managed permissions. Specified users may have rights to different functions within the system, and manage them separately and simultaneously.

Similarly, a global administration module may be provided for system administrators and managers, who manage a system that include multiple brands and community databases. Specified users may have rights to different functions within the system, and manage them separately and simultaneously. These rights can be assigned in a highly specialized and customized fashion, not requiring broad definitions applicable or provided to all.

The power and strength of the integrated marketing system described herein is shown in the following nonexclusive and nonlimiting examples.

### EXAMPLE 1

### Female Singer

Female Singer (the “brand”) desires to launch a new website and online fanclub. She has a website and fan community already centered around a site managed by her record label, but the site and the information contained in the community is, ultimately, the property of the record label. Female Singer and her management team desire to build an online community that she would control as her career progressed, regardless of label affiliation. They also desired to build a significant online presence for her that would allow her to capitalize on new sponsorship and promotional opportunities as the overall traffic to her site continues to grow.

Female Singer and her management team purchase her website domain name from a third party, and use the invention to design and develop the main web site, including exclusive photos and videos. A community database is initiated, and an official online fan club is launched. Fan club membership order, and ticket orders, are taken through the web site and fulfilled through the web site. A marketing plan is employed, including initiation of a three-month paid ad search campaign, and the top 5 listing at each of the major search engines is generated to provide the next steps in increasing and improving the singer's online presence. A radio web site strategy is implemented, employing members of the community to assist in securing links on radio websites and in generating exposure for the release of a new album. Meet and greets with fan club members at each show on the current tour are arranged. An exclusive pre-release to fan club members of her first DVD is distributed. Her allotment of concert tickets for the current tour are sold through the web site. An online partnership with the “Got Milk” campaign is arranged: “Got Milk” gives away a number of fan club membership through contests, data for which is provided from the web site, and information about the contests and the “Got Milk” campaign is updated on her web site and emailed to the email list.

Within months after the launch of the web site, it averages over 8 million unique visitors per month, with as many as 10 million in some months. Over 80,000 community members have opted-in (there are not 138,000 users), and receive official communications from the web site each month, thereby being made aware of new products, events, and offers. Members of the online subscription fan club pay annual fees through the site, and gain access to additional exclusive information and features, such as online VIP ticketing, concert meet and greets, streaming video, exclusive photo galleries, and the like. Upon registering for the fan club, members are each issued unique usernames and passwords that allow access to the additional content. Fan club members also purchase front-of-house VIP concerts through the web site, and have access to ongoing behind-the-scenes video footage during her current tour.

The system also provides her the ability to create effective renewal communications to paid members, and she experiences a significant amount of success in the response to renewal messages sent to notify those with soon-to-expire memberships. The system enables tracking of all renewal communications, including open rates, click-through rates, and bounces, all of which are captured for analysis.

### EXAMPLE 2

### Male Recording Artist

A recording artist with an existing online web site and fan club desires a web site redesign and also wants to capitalize on the evangelistic fervor of top fans, channeling their energy into useful activities to grow the overall fan base and increase demand for his albums. A street team of top potential evangelists is formed. Initially, all individuals on an existing email list are emailed an invitation to join the street team. A database is built from surveys and the ongoing exchange of communications with interested individuals. Potential street team members are asked to fill out a profile, including favorite songs by the recording artist, radio stations listened to, magazines read, date of birth, and contact information. This information is supplemented on an ongoing basis with information from each individual's frequency of site visits, street team email open rates, and the number of posts that each member makes on message boards at the new web site. This information allows the marketing team to identify street team members suited for certain tasks or events.

The street team was tested as an evangelism force during a two-month tour of colleges. Street team members were initially invited to participate via email, which required each participant complete an in-depth profile of themselves. The two top participants were identified in each market (i.e., concert location) and were contacted with instructions (back-ups for each area also were identified, and contacted if no response from initial contactees was received by a deadline). The two street team members in each market who agreed to carry out the task were provided with packages containing two 11″×17″ posters and 100 serialized cards to hand out at local events and concerts, each card containing a password-protected entry to a free music downloads page features certain songs. Members also received an additional question-and-answer sheet prior to the event. Team members were instructed to pass along the cards to non-fans only. Card redemptions were tracked online, and due to the serialized numbering, could be tracked to particular team members. The top ten team members, based on the most tracked redemptions, won a prize pack, including a signed tour poster, signed CDs, and a T-shirt. The top overall winner received a personal phone call from the recording artist.

Instead of a typical direct marketing result of approximately 1%, 17% of the cards using the above method were redeemed. Fewer than half of the redemptions occurred during the concert tour itself, while most of the remainder occurred with the five-month period following the end of the tour (although cards were still being redeemed up to a year later). Thirty-five percent of the redeemers were between the ages of 21-25, and 80% indicated that they would be interested in receiving text messages about the recording artist. The system also provided the ability to look at the ROI of the recipients at the time of the concerts, and compare that to the ROI at later points in time.

Overall, about 15% of opt-ins in the fan database took the extra step of signing up to become street team members. About half of the street team members are evangelists, i.e., very active, consistently opening email, responding to offers, and posting on message boards.

Subsequently, when shooting a music video, the background was filled with street teamers instead of actors or models. It has been found that activities such as this keep the “evangelists” involved. Emails were sent to all street teamers with an invitation to participate, along with an application (including cell phone number and carrier) to be considered. After reviewing available data in the application and database, several dozen team members were selected for the video, with the actual location of the video shoot text messaged to the winner's cell phones on the actual day of the shoot.

The recording artist's community has over 77,000 members, 9800 of which are street teamers. Team members play a crucial role in securing higher profile placement on key Internet music sites (including an exclusive photo gallery, and have shown proven ability to drive a video to the top-10 in the genre. Web site hits have doubled, with concomitant growth in bandwidth usage. The artist has publicly stated that the team has impacted his visibility as much as or more than traditional radio.

Other elements of the system used by the recording artist include the sales of VIP tickets to fan club members, placing reviews and features on relevant music sites, establishing reciprocal links with other large artist sites, radio station websites, fan-driven promotions for streaming audio and video, and working with tour venues to market tour events. Aggregate data from the system has been, and is being, used to secure corporate sponsorships, as well as to assist in planning marketing strategies for releases.

### EXAMPLE 3

### Corporate Sponsor

An industrial manufacturer became the corporate sponsor for a particular band's concert series, and sought to build upon the success of the album presale and promotion by offering a free sweepstakes to a segment of the band's fan base. The corporate sponsor used the system to design, develop, drive and maintain a custom web site to promote the tour and sweepstakes. The marketing campaign involved a kickoff that included sending an email to the fan base announcing the sweepstakes/contest and the online promotions. The campaign was strategically timed and positioned to drive fan traffic specifically to the contest site. There were eight shows scheduled in the Southeast region for the concert series and users were encouraged to enter to win two tickets to each show. As part of the contest entry, users were also asked a series of questions about their purchasing patterns for the manufacturer's product. Over a two-month period, the promotion/contest created 15,000 leads for the manufacturer—the largest amount ever generated by one of their online promotions. This campaign's success assisted them with immediate business and marketing decisions and they were able to identify and secure a community of individuals with whom they can continue ongoing, meaningful conversations in the future.

### EXAMPLE 4

### Cable Channel

A cable channel desired to develop and implement a comprehensive brand convergence strategy. It desired assistance in significantly boosting user traffic to its web site and growing the size of its overall online community. It wanted to create, as a digital cable channel, an online presence that would retain and monetize on site traffic generated by the programming. It also wanted a new site to function as a standalone business unit to create additional revenue streams for a company that would function independent of the cable channel presence.

To accomplish these goals, a new site was designed and launched using the system. The new site possessed the visual effect and the texture consistent with the vision of the cable channel, thereby remaining in line with the corporate and visual branding of the programming. The success of the site has established their brand as the trusted and primary source for their content, and has allowed them to explore new revenue producing opportunities online, including ecommerce and paid memberships. Ad-serving software has allowed the brand to begin targeted on-site advertising.

To further increase online community growth, the cable channel used the system to develop and implement various marketing campaigns and strategic cross promotions. It also utilized various online portals to activate targeted demographics and drive user traffic to the site.

Since the successful launch of the new site, user traffic for the site has tripled. The channel is engaging in a contest with a significant online component, which is being managed through the site. This includes managing all of the sign-ups for the contest, compiling all of the online auditions, and coordinating the entire online voting process.

### EXAMPLE 5

### Author

A successful book author with a healthy readership desired a new web site to help coordinate various promotions, including book releases. He began by enlisting street team members, and used a web form designed by the system to gather specific personal information from the members interested. A communication sent to an existing mailing list used the double opt-in methodology, and include a click-through link to the web form, which was located on the new web site. Nearly one half of the existing online community opened the email, and one half of those clicked through to the site. Of those, 80% signed on to become part of the street team. Using the system, the author was able to see the progress of this process, including every piece of information provided, everyone that opened and/or clicked through, and everyone that signed on to be part of the street team.

Shortly thereafter, the street team was employed to assist in the introduction of a new novel (i.e., the street team mission). Each member was provided a unique identifier for their membership, a login to a special site for the kickoff, and the encouragement of being eligible to collect specified rewards and points for meeting particular marketing goals (points being exchangeable for product related to the author). The system organized the street team mission, and the distribution of assignments to all team members, and then provided detailed information about each member's activities, successes, and point levels.

Thus, it should be understood that the embodiments and examples have been chosen and described in order to illustrate best the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A system for creating brand intimacy with customers, comprising:
a database structure, comprising one or more databases adapted to contain a plurality of information about individuals and activities related to a brand;
one or more data sources for said information, further wherein at least one of said data sources comprises voluntary, double opt-in information obtained directly from an individual;
one or more communication means, said communication means adapted to provide information about the brand to an audience;
a content management module, said module adapted to manage the information provided to the audience based upon the information in the database structure; and
one or more dynamic filters, said filters adapted to sort some or all of the data in the database structure for marketing purposes, further wherein the results of said filters are automatically updated to reflect new information added to the database structure.

2. The system of claim 1, further comprising a central web site adapted to serve as the focal point of the brand for the audience of consumers and potential consumers.

3. The system of claim 2, further comprising a web site formation module.

4. The system of claim 1, further comprising a content display device, adapted to display the information provided about the brand to the audience.

5. The system of claim 1, wherein said communications means comprises email.

6. The system of claim 1, wherein said communications means comprises text messaging.

7. The system of claim 1, wherein said communications means comprises voice messaging.

8. The system of claim 1, wherein said marketing purposes comprises a marketing campaign.

9. The system of claim 7, further comprising means for tracking the performance of the marketing campaign.

10. The system of claim 8, further wherein information about the performance of the marketing campaign is stored in the database structure.

11. The system of claim 1, further wherein some or all of said communications are tracked by the system, and information about said tracked communications is stored in the database structure.
